(19) United States
(12) Patent Application Publication
(10) Pub. No.: US 2005/0112264 A1
(43) Pub. Date: May 26, 2005

(54) Concentrated nutritional marinade having a smooth consistency free of bits and chunks

(76) Inventor: Gregory Stavroulakis, Coram, NY (US)

Correspondence Address: Gregory Stavroulakis, 3 Hanson Way, Coram, NY, 11727, US

(21) Appl. No.: 10/722,666

(22) Filed: Nov. 26, 2003

(51) Int. Cl. A23L 1/238

(52) U.S. Cl. 426/589

(57) ABSTRACT

A concentrated nutritional marinade having a smooth consistency free of bits and chunks that includes olive oil, onion, garlic, fresh basil, fresh lemon juice, salt, pepper, and oregano. The olive oil, the onion, the garlic, the fresh basil, the fresh lemon juice, the salt, the pepper, and the oregano are blended in a blender to form a nutritional marinade having a smooth consistency free of bits and chunks. The nutritional marinade having a smooth consistency free of bits and chunks is then frozen to form the concentrated nutritional marinade having a smooth consistency free of bits and chunks.

### BACKGROUND OF THE INVENTION

1. Field of the Invention

The present invention relates to a marinade. More particularly, the present invention relates to a concentrated nutritional marinade having a smooth consistency free of bits and chunks.

2. Description of the Prior Art

Numerous innovations for sauces have been provided in the prior art that will be described. Even though these innovations may be suitable for the specific individual purposes to which they address, however, they differ from the present invention.

FOR EXAMPLE, U.S. Pat. No. 5,958,498 to Trueck et al. teaches a mayonnaise-like emulsion product that has a component composition which includes edible oil, sugar and salt components, first and second emulsifier components and an acetic acid or vinegar component and by weight, the oil component is in an amount of from 55% to 85%, the sugar component is in an amount of at least 1%, the salt component is in an amount of at least 0.5% and the acetic acid or vinegar component is in an amount of from 0.1% to 20% so that the emulsion has a pH of from 2 to 5, the first emulsifier component being soya protein, pea protein, skimmed milk powder, buttermilk and/or casein, and wherein heat denaturable proteins of the first emulsifier are denatured to a degree of denaturation between 70% and 80%, and the second emulsifier component being a monoglyceride, an ethoxylated monoglyceride, a polyoxyethylene sorbitan, glycerin, a fatty acid monoester and/or a fatty acid diester. The emulsion product is prepared by mixing water, sugar, salt and the first and second emulsifiers, heating the mixture so prepared to denature proteins in the mixture which are heat-denaturable to a degree of denaturation between 70% and 80%, cooling the heat-treated mixture, adding the acetic acid or vinegar to acidify the cooled mixture, adding an edible oil to the acidified mixture and then homogenizing the oil-containing product.

ANOTHER EXAMPLE, U.S. Pat. No. 5,885,644 to Dean teaches a garlic sauce that includes garlic, slivered nuts, vinegar, water, oil, and salt. These ingredients are combined without the addition of exogenous starch. A method of preparing the garlic sauce includes preconditioning nuts with garlic by dry blending to form a substantially homogeneous dough-like mixture, mixing vinegar, water, and salt into the dough-like mixture to form a substantially homogeneous batter, and adding oil to the dough to form a uniformly chunky, crunchy, and spreadable sauce with a rich golden hue.

STILL ANOTHER EXAMPLE, U.S. Pat. No. 5,104,679 to Jurcso teaches a shakable, edible composition that comprises a continuous aqueous phase having stably suspended first oil droplets. A second oil phase normally forms an upper layer contiguous with the continuous aqueous phase when the composition stands in a container, but the second oil phase is dispersible into the aqueous phase as second oil droplets upon sufficient shaking. The stably dispersed first oil droplets increase the ease of mixing the second oil phase with the aqueous phase and can provide improved organoleptic characteristics for compositions of the invention.

It is apparent that numerous innovations for sauces have been provided in the prior art that are adapted to be used. Furthermore, even though these innovations may be suitable for the specific individual purposes to which they address, however, they would not be suitable for the purposes of the present invention as heretofore described.

### SUMMARY OF THE INVENTION

ACCORDINGLY, AN OBJECT of the present invention is to provide a concentrated nutritional marinade having a smooth consistency free of bits and chunks that avoids the disadvantages of the prior art.

ANOTHER OBJECT of the present invention is to provide a concentrated nutritional marinade having a smooth consistency free of bits and chunks that is simple and inexpensive to manufacture.

STILL ANOTHER OBJECT of the present invention is to provide a concentrated nutritional marinade having a smooth consistency free of bits and chunks that is simple to use.

BRIEFLY STATED, YET ANOTHER OBJECT of the present invention is to provide a concentrated nutritional marinade having a smooth consistency free of bits and chunks that includes olive oil, onion, garlic, fresh basil, fresh lemon juice, salt, pepper, and oregano. The olive oil, the onion, the garlic, the fresh basil, the fresh lemon juice, the salt, the pepper, and the oregano are blended in a blender to form a nutritional marinade having a smooth consistency free of bits and chunks. The nutritional marinade having a smooth consistency free of bits and chunks is then frozen to form the concentrated nutritional marinade having a smooth consistency free of bits and chunks.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIG. 1 is a block diagram of the present invention; and

FIGS. 2A-2E are a flow diagram of the process of making the present invention;

### LIST OF REFERENCE NUMERALS UTILIZED IN THE DRAWING

10 concentrated nutritional marinade having smooth consistency free of bits and chunks of present invention
12 olive oil for fighting heart disease by reducing bad cholesterol while raising good cholesterol, for supplying vitamin E which provides a younger look by retarding cellular aging due to oxidation, helps prevent lipid peroxidation, increases endurance by supplying more oxygen, protects lungs against air pollution, prevents and dissolves blood clots, alleviates fatigue, lowers blood pressure by working as a diuretic, prevents miscarriages, alleviates leg cramps, and lowers risk of ischemic heart disease, and for supplying vitamin F which aids in preventing cholesterol deposits in arteries, gives some degree of protection against harmful effects of X-rays, promotes healthy skin and hair, aids in growth and well-being by influencing glandular activity and making calcium available to cells, combats heart disease, and aids in weight reduction by burning saturated fats
14 onion for lowering cholesterol, for supplying quercertin which is not destroyed by cooking and which suppresses malignant cells before they become tumors, for combating yeast fungus, and for supplying iodine which improves mental alacrity and promotes healthy hair, nails, skin, and teeth
16 garlic for lowering cholesterol, for cleaning blood of excess glucose, for reducing high blood pressure by neutralizing poisonous substances in intestines and acting as a vaso-dilator, for supplying allicin which is a natural antibiotic and which destroys disease germs without sweeping away friendly bacteria in the process, for supplying potassium, phosphorous, vitamins B and C, calcium, and protein, for alleviating grippe, sore throat, and bronchial congestion, and for combating yeast fungus
18 fresh basil
20 fresh lemon juice for suppling vitamin C and for lowering cholesterol
22 salt for aiding in preventing heat prostration and for helping nerves and muscles function properly
24 pepper for lowering cholesterol
26 oregano
28 blender
30 first composition
32 second composition
34 third composition
36 fourth composition
38 fifth composition
40 sixth composition
42 seventh composition
44 nutritional marinade having smooth consistency free of bits and chunks

### DETAILED DESCRIPTION OF THE PREFERRED EMBODIMENT

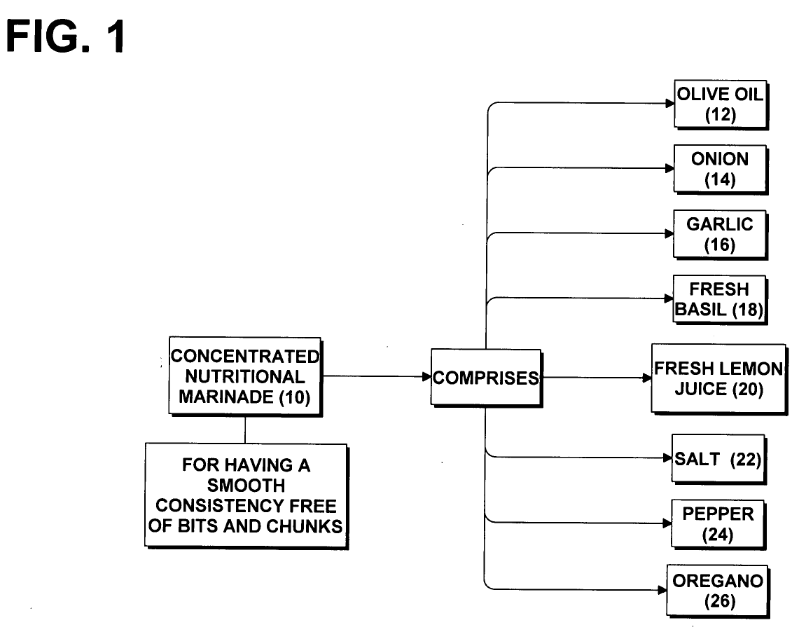

Referring now to the figures, in which like numerals indicate like parts, and particularly to FIG. 1, which is a block diagram of the present invention, the concentrated nutritional marinade having a smooth consistency free of bits and chunks of the present invention is shown generally at 10.

The composition of the concentrated nutritional marinade having a smooth consistency free of bits and chunks 10 can best be seen in FIG. 1, which again is a block diagram of the present invention, and as such, will be discussed with reference thereto.

The concentrated nutritional marinade having a smooth consistency free of bits and chunks 10 comprises olive oil 12 for fighting heart disease by reducing bad cholesterol while raising good cholesterol, for supplying vitamin E which provides a younger look by retarding cellular aging due to oxidation, helps prevent lipid peroxidation, increases endurance by supplying more oxygen, protects lungs against air pollution, prevents and dissolves blood clots, alleviates fatigue, lowers blood pressure by working as a diuretic, prevents miscarriages, alleviates leg cramps, and lowers risk of ischemic heart disease, and for supplying vitamin F which aids in preventing cholesterol deposits in arteries, gives some degree of protection against harmful effects of X-rays, promotes healthy skin and hair, aids in growth and well-being by influencing glandular activity and making calcium available to cells, combats heart disease, and aids in weight reduction by burning saturated fats.

The concentrated nutritional marinade having a smooth consistency free of bits and chunks 10 further comprises onion 14 for lowering cholesterol, for supplying quercertin which is not destroyed by cooking and which suppresses malignant cells before they become tumors, for combating yeast fungus, and for supplying iodine which improves mental alacrity and promotes healthy hair, nails, skin, and teeth.

The concentrated nutritional marinade having a smooth consistency free of bits and chunks 10 further comprises garlic 16 for lowering cholesterol, for cleaning blood of excess glucose, for reducing high blood pressure by neutralizing poisonous substances in intestines and acting as a vaso-dilator, for supplying allicin which is a natural antibiotic and which destroys disease germs without sweeping away friendly bacteria in the process, for supplying potassium, phosphorous, vitamins B and C, calcium, and protein, for alleviating grippe, sore throat, and bronchial congestion, and for combating yeast fungus.

The concentrated nutritional marinade having a smooth consistency free of bits and chunks 10 further comprises fresh basil 18.

The concentrated nutritional marinade having a smooth consistency free of bits and chunks 10 further comprises fresh lemon juice 20 for suppling vitamin C and for lowering cholesterol.

The concentrated nutritional marinade having a smooth consistency free of bits and chunks 10 further comprises salt 22 for aiding in preventing heat prostration and for helping nerves and muscles function properly.

The concentrated nutritional marinade having a smooth consistency free of bits and chunks 10 further comprises pepper 24 for lowering cholesterol.

The concentrated nutritional marinade having a smooth consistency free of bits and chunks 10 further comprises oregano 26.

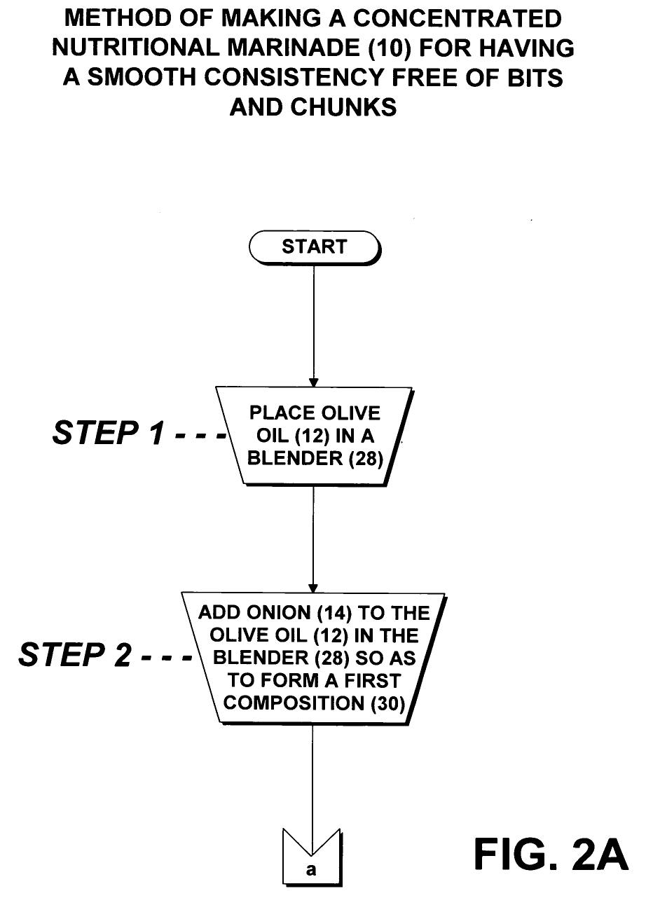

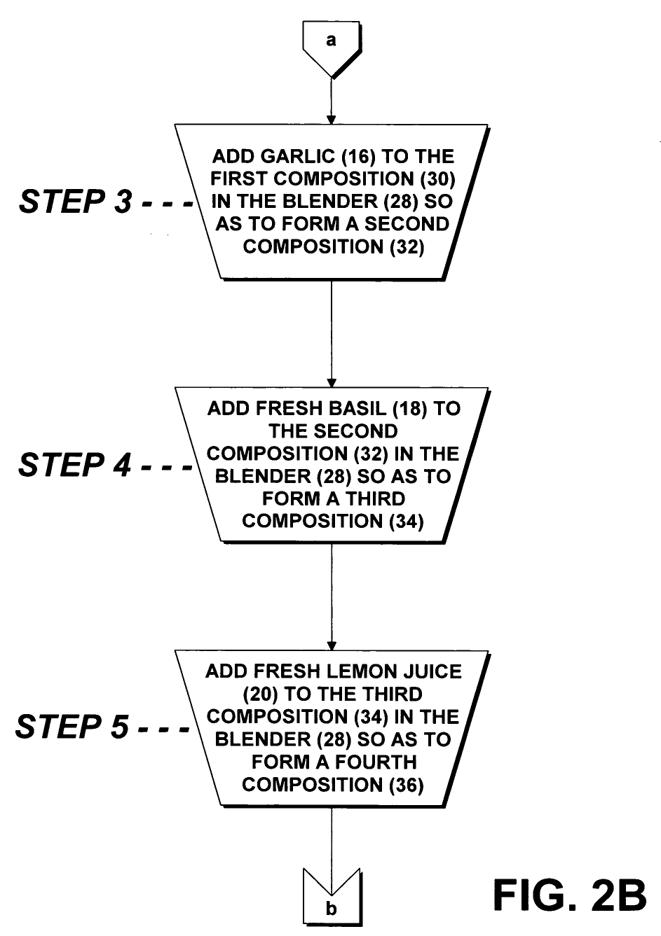

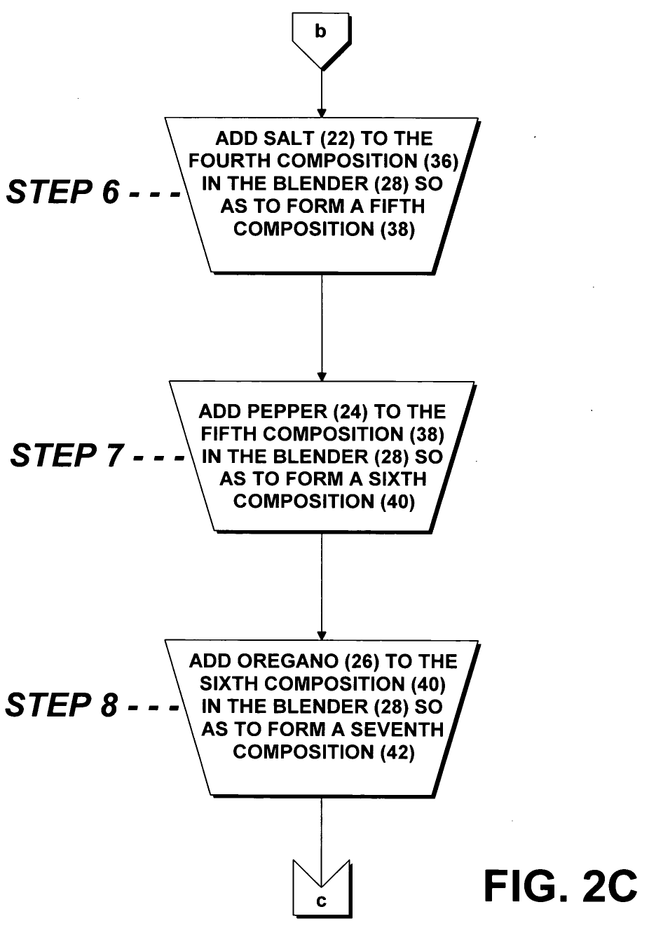

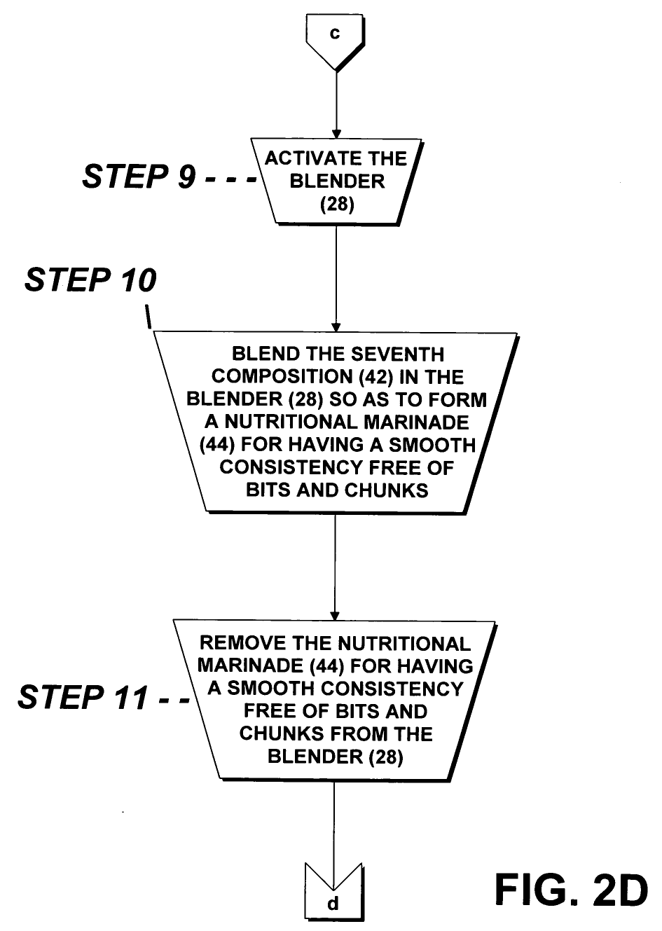

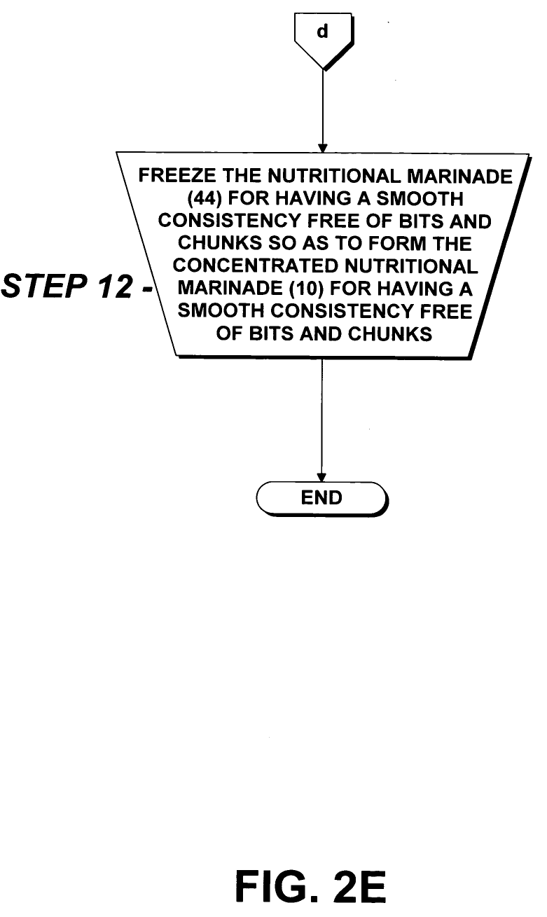

The method of making the concentrated nutritional marinade having a smooth consistency free of bits and chunks 10 can best be seen in FIGS. 2A-2E, and as such, will be discussed with reference thereto.
STEP 1: Place the olive oil 12 in a blender 28, wherein the olive oil 12 is for fighting heart disease by reducing bad cholesterol while raising good cholesterol, for supplying vitamin E which provides a younger look by retarding cellular aging due to oxidation, helps prevent lipid peroxidation, increases endurance by supplying more oxygen, protects lungs against air pollution, prevents and dissolves blood clots, alleviates fatigue, lowers blood pressure by working as a diuretic, prevents miscarriages, alleviates leg cramps, and lowers risk of ischemic heart disease, and for supplying vitamin F which aids in preventing cholesterol deposits in arteries, gives some degree of protection against harmful effects of X-rays, promotes healthy skin and hair, aids in growth and well-being by influencing glandular activity and making calcium available to cells, combats heart disease, and aids in weight reduction by burning saturated fats.
STEP 2: Add the onion 14 to the olive oil 12 in the blender 28 so as to form a first composition 30, wherein the onion 14 is for lowering cholesterol, for supplying quercertin which is not destroyed by cooking and which suppresses malignant cells before they become tumors, for combating yeast fungus, and for supplying iodine which improves mental alacrity and promotes healthy hair, nails, skin, and teeth.
STEP 3: Add the garlic 16 to the first composition 30 in the blender 28 so as to form a second composition 32, wherein the garlic 16 is for lowering cholesterol, for cleaning blood of excess glucose, for reducing high blood pressure by neutralizing poisonous substances in intestines and acting as a vaso-dilator, for supplying allicin which is a natural antibiotic and which destroys disease germs without sweeping away friendly bacteria in the process, for supplying potassium, phosphorous, vitamins B and C, calcium, and protein, for alleviating grippe, sore throat, and bronchial congestion, and for combating yeast fungus.
STEP 4: Add fresh basil 18 to the second composition 32 in the blender 28 so as to form a third composition 34.
STEP 5: Add the fresh lemon juice 20 to the third composition 34 in the blender 28 so as to form a fourth composition 36, wherein the fresh lemon juice 20 is for supplying vitamin C and for lowering cholesterol.
STEP 6: Add the salt 22 to the fourth composition 36 in the blender 28 so as to form a fifth composition 38, wherein the salt 22 is for aiding in preventing heat prostration and for helping nerves and muscles function properly.
STEP 7: Add the pepper 24 to the fifth composition 38 in the blender 28 so as to form a sixth composition 40, wherein the pepper 24 is for lowering cholesterol.
STEP 8: Add the oregano 26 to the sixth composition 40 in the blender 28 so as to form a seventh composition 42.
STEP 9: Activate the blender 28.
STEP 10: Blend the seventh composition 42 in the blender 28 so as to form a nutritional marinade having a smooth consistency free of bits and chunks 44.
STEP 11: Remove said nutritional marinade having a smooth consistency free of bits and chunks 44 from the blender 28.
STEP 12: Freeze the nutritional marinade having a smooth consistency free of bits and chunks 44 so as to form the concentrated nutritional marinade having a smooth consistency free of bits and chunks 10.

It will be understood that each of the elements described above, or two or more together, may also find a useful application in other types of constructions differing from the types described above.

While the invention has been illustrated and described as embodied in a concentrated nutritional marinade having a smooth consistency free of bits and chunks, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

1. A concentrated nutritional marinade having a smooth consistency free of bits and chunks, comprising:
a) olive oil for fighting heart disease by reducing bad cholesterol while raising good cholesterol, for supplying vitamin E which provides a younger look by retarding cellular aging due to oxidation, helps prevent lipid peroxidation, increases endurance by supplying more oxygen, protects lungs against air pollution, prevents and dissolves blood clots, alleviates fatigue, lowers blood pressure by working as a diuretic, prevents miscarriages, alleviates leg cramps, and lowers risk of ischemic heart disease, and for supplying vitamin F which aids in preventing cholesterol deposits in arteries, gives some degree of protection against harmful effects of X-rays, promotes healthy skin and hair, aids in growth and well-being by influencing glandular activity and making calcium available to cells, combats heart disease, and aids in weight reduction by burning saturated fats;
b) onion for lowering cholesterol, for supplying quercertin which is not destroyed by cooking and which suppresses malignant cells before they become tumors, for combating yeast fungus, and for supplying iodine which improves mental alacrity and promotes healthy hair, nails, skin, and teeth; and
c) garlic for lowering cholesterol, for cleaning blood of excess glucose, for reducing high blood pressure by neutralizing poisonous substances in intestines and acting as a vaso-dilator, for supplying allicin which is a natural antibiotic and which destroys disease germs without sweeping away friendly bacteria in said process, for supplying potassium, phosphorous, vitamins B and C, calcium, and protein, for alleviating grippe, sore throat, and bronchial congestion, and for combating yeast fungus.

2. The marinade as defined in claim 1; further comprising fresh basil.

3. The marinade as defined in claim 1; further comprising fresh lemon juice for suppling vitamin C and for lowering cholesterol.

4. The marinade as defined in claim 1; further comprising salt for aiding in preventing heat prostration and for helping nerves and muscles function properly.

5. The marinade as defined in claim 1; further comprising pepper for lowering cholesterol.

6. The marinade as defined in claim 1; further comprising oregano.

7. A method of making a concentrated nutritional marinade having a smooth consistency free of bits and chunks, comprising the steps of:
a) placing olive oil in a blender, wherein said olive oil is for fighting heart disease by reducing bad cholesterol while raising good cholesterol, for supplying vitamin E which provides a younger look by retarding cellular aging due to oxidation, helps prevent lipid peroxidation, increases endurance by supplying more oxygen, protects lungs against air pollution, prevents and dissolves blood clots, alleviates fatigue, lowers blood pressure by working as a diuretic, prevents miscarriages, alleviates leg cramps, and lowers risk of ischemic heart disease, and for supplying vitamin F which aids in preventing cholesterol deposits in arteries, gives some degree of protection against harmful effects of X-rays, promotes healthy skin and hair, aids in growth and well-being by influencing glandular activity and making calcium available to cells, combats heart disease, and aids in weight reduction by burning saturated fats;
b) adding onion to said olive oil in said blender so as to form a first composition, wherein said onion is for lowering cholesterol, for supplying quercertin which is not destroyed by cooking and which suppresses malignant cells before they become tumors, for combating yeast fungus, and for supplying iodine which improves mental alacrity and promotes healthy hair, nails, skin, and teeth;
c) adding garlic to said first composition in said blender so as to form a second composition, wherein said garlic is for lowering cholesterol, for cleaning blood of excess glucose, for reducing high blood pressure by neutralizing poisonous substances in intestines and acting as a vaso-dilator, for supplying allicin which is a natural antibiotic and which destroys disease germs without sweeping away friendly bacteria in said process, for supplying potassium, phosphorous, vitamins B and C, calcium, and protein, for alleviating grippe, sore throat, and bronchial congestion, and for combating yeast fungus;
d) activating said blender;
e) blending said second composition in said blender so as to form a nutritional marinade having a smooth consistency free of bits and chunks;
f) removing said nutritional marinade having a smooth consistency free of bits and chunks from said blender; and
g) freezing said nutritional marinade having a smooth consistency free of bits and chunks so as to form said concentrated nutritional marinade having a smooth consistency free of bits and chunks.

8. The method as defined in claim 7; further comprising the step of adding fresh basil to said second composition in said blender.

9. The method as defined in claim 7; further comprising the step of adding fresh lemon juice to said second composition in said blender, wherein said fresh lemon juice is for suppling vitamin C and for lowering cholesterol.

10. The method as defined in claim 7; further comprising the step of adding salt to said second composition in said blender, wherein said salt is for aiding in preventing heat prostration and for helping nerves and muscles function properly.

11. The method as defined in claim 7; further comprising the step of adding pepper to said second composition in said blender, wherein said pepper is for lowering cholesterol.

12. The method as defined in claim 7; further comprising the step of adding oregano to said second composition in said blender.
